(19) United States
(12) Patent Application Publication
(10) Pub. No.: US 2025/0086340 A1
(43) Pub. Date: Mar. 13, 2025

(54) DIGITAL TWIN-BASED PRESSURE VESSEL SAFETY EVALUATION AND RISK WARNING METHOD

(71) Applicant: EAST CHINA UNIVERSITY OF SCIENCE AND TECHNOLOGY, Shanghai (CN)

(72) Inventors: Fuzhen XUAN, Shanghai (CN); Jianguo GONG, Shanghai (CN); Yang GAO, Shanghai (CN); Mingliang ZHU, Shanghai (CN); Yanxun XIANG, Shanghai (CN)

(21) Appl. No.: 18/705,684

(22) PCT Filed: Dec. 13, 2021
(86) PCT No.: PCT/CN2021/137552

§ 371 Date: Apr. 29, 2024

(30) Foreign Application Priority Data
Nov. 19, 2021 (CN) 202111399511.1

(51) Int. Cl. G06F 30/17; G06F 30/23

(52) U.S. Cl. CPC G06F 30/17; G06F 30/23

(57) ABSTRACT

A digital twin-based pressure vessel safety evaluation and risk warning method includes steps: S1, determine a damage mode of pressure vessel; S2, design an overall plan of pressure vessel safety evaluation and risk warning; S3, simplify physical model of the pressure vessel and build a simplified physical model based on designed overall plan; S4, obtain load condition parameters during actual service of the pressure vessel; S5, determine material performance parameters of the pressure vessel; S6, build a digital twin model of pressure vessel safety evaluation and risk warning; S7, obtain a full-field damage distribution cloud map of the pressure vessel; S8, compare the full-field damage distribution cloud map and strength requirement of material of pressure vessel, if the strength requirement is met, conduct a safety evaluation at next time node according to subsequent needs of user, and if the strength requirement is not met, output a pressure vessel risk warning.

### BACKGROUND OF THE INVENTION

### 1. Field of the Invention

The present application relates to the field of pressure vessel safety evaluation and risk warning, more specifically relates to a digital twin-based pressure vessel safety evaluation and risk warning method.

### 2. Related Art

Pressure vessels are widely used in industries such as petroleum, chemical, nuclear power, thermal power, aviation and aerospace, they often face the combined effects of harsh service environments (e.g. high temperature and pressure) and extreme media (e.g. corrosive and toxic media). It can be foreseen that there are many potential major damage models in the service of pressure vessels. Once these components fail, it will cause huge economic losses and even lead to environmental and social problems. Therefore, the safety evaluation and risk warning of pressure vessel have always been an important issue which is exposed to the pressure vessel industry.

The existing safety evaluation and risk warning technologies for pressure vessels are mostly based on offline data or design data, which cannot achieve the systematic integration and synchronous calculation of high-temperature structural safety evaluation method and pressure vessel service parameters. Therefore, they cannot reflect the damage evolution behavior in the service of pressure vessel in real time. At the same time, they also cannot display high risk parts of pressure vessel according to the damage evolution of the pressure vessel in real time, making it difficult to achieve service risk warning for parts of pressure vessel. The above problems restrict the precise acquisition of the damage evolution status of pressure vessel by those skilled in the art, and cannot fully guarantee the long-term safe service of pressure vessel.

Although there are technical contents such as real-time data acquisition and online display in the existing field of mechanical engineering, these applications have not achieved direct connection between real-time data acquisition and life assessment methods nor embedded relevant contents such as finite element analysis and safety evaluation method.

### SUMMARY OF THE INVENTION

The purpose of the present application is to provide a digital twin-based pressure vessel safety evaluation and risk warning method, in order to achieve the connection between the real-time acquisition of service parameters and subsequent life evaluation method, and to achieve real-time output of pressure vessel risk warning signals according to the evolution of pressure vessel damage.

The present application provides a digital twin-based pressure vessel safety evaluation and risk warning method, which comprises the following steps:
S1: determining a damage mode of the pressure vessel based on design parameters of the pressure vessel and material category of the pressure vessel;
S2: designing an overall plan of the pressure vessel safety evaluation and risk warning based on determined damage mode;
S3: simplifying a physical model of the pressure vessel and building a simplified physical model based on designed overall plan;
S4: obtaining load condition parameters during actual service of the pressure vessel;
S5: determining material performance parameters of the pressure vessel according to the designed overall plan;
S6: building a digital twin model of the pressure vessel safety evaluation and risk warning according to the simplified physical model in step S3, the load condition parameters in step S4 and material performance parameters in step S5;
S7: conducting a safety evaluation on the digital twin model of the pressure vessel safety evaluation and risk warning, and obtaining a full-field damage distribution cloud map of the pressure vessel;
S8: comparing the full-field damage distribution cloud map and strength requirement of material of the pressure vessel, if the strength requirement is met, conducting a safety evaluation at next time node according to subsequent needs of user, and if the strength requirement is not met, outputting a pressure vessel risk warning.

Preferably, the design parameters include a design temperature and whether there is a cyclic load or not.

Preferably, the material category of the pressure vessel is Cr-Mo steel or austenitic steel.

Preferably, the damage mode of the pressure vessel includes creep damage, creep-fatigue damage and fatigue damage.

Preferably, in step S3, the physical model of the pressure vessel is simplified by ignoring non-pressure-bearing components, flange bolts and gaskets, and weld fillet structures of non-load-bearing components.

Preferably, the overall plan in step S2 is designed by using American Society of Mechanical Engineers Specifications or non-elastic finite element analysis method.

Preferably, the load condition parameters include a temperature and a pressure.

Preferably, in step S4, a temperature sensor and a pressure sensor are used to collect the temperature and pressure of the pressure vessel respectively.

Preferably, the material performance parameters of the pressure vessel are obtained by querying in specifications or design manuals or by performing material mechanical property test.

Preferably, step S6 further includes: importing the simplified physical model in step S3 into ABAQUS software directly, then converting simulated signals of temperature and pressure in step S4 into digital signals through an A/D converter, and inputting the digital signals and material property parameters in step S5 into ABAQUS software by using a Python language.

The digital twin-based pressure vessel safety evaluation and risk warning method of the present application can realize the connection of real-time acquisition of pressure vessel service parameters and subsequent life evaluation method, and can overcome the problem that the existing safety evaluation and risk warning technologies for pressure vessel are mostly based on offline data or design data. At the same time, it can also realize the real-time output of pressure vessel risk warning signals based on the evolution of the pressure vessel damage. Specifically, the sensors are used to monitor the operating condition information of the pressure vessel in real time, providing data support for subsequent safety evaluation of pressure vessel. On this basis, automatic and real-time calculation of pressure vessel damage parameters are realized in finite element software by using user subroutines, and online life evaluation of related components can be achieved. At the same time, related calculation results and local dangerous areas can be displayed in real time, and pressure vessel service risk warning can be realized.

### BRIEF DESCRIPTION OF THE DRAWINGS

FIG. 1 is a flowchart of a digital twin-based pressure vessel safety evaluation and risk warning method according to an embodiment of the present application;

FIG. 2 is a flowchart of pressure vessel creep fatigue damage evaluation in ASME Specifications according to an embodiment of the present application;

FIG. 3 shows the creep fatigue interaction diagram of a typical high-temperature material according to an embodiment of the present application.

### DESCRIPTION OF THE ENABLING EMBODIMENT

In conjunction with the accompanying drawings, preferred embodiments of the present application are given and described in detail below.

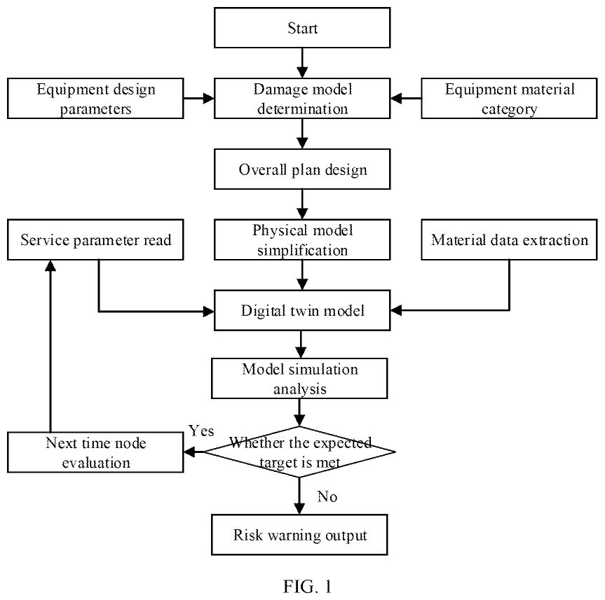

As shown in FIG. 1, an embodiment of the present application provides a digital twin-based pressure vessel safety evaluation and risk warning method, which includes the following steps:

S1: determine a damage mode of pressure vessel based on design parameters of pressure vessel and material category of pressure vessel.

The design parameters include design temperature and whether there is a cyclic load or not, the material category can determine the creep initiation temperature, the common materials of pressure vessel include Cr—Mo steel and austenitic steel, with creep initiation temperatures of 375° C. and 427° C. respectively. The damage mode of pressure vessel includes creep damage, creep-fatigue damage and fatigue damage, which can be determined based on specific design parameters and material category. Specifically, if a steady-state operating temperature of the pressure vessel exceeds a creep initiation temperature, there is creep; if the pressure vessel is subjected to a cyclic load, there is fatigue; if the steady-state operating temperature exceeds the creep initiation temperature and the pressure vessel is subjected to a cyclic load, there is creep-fatigue.

In some embodiments, the material category of pressure vessel is austenitic steel, the design temperature is 550° C., there is a cyclic load during service, and the damage mode of the pressure vessel is creep-fatigue.

S2: design an overall plan of pressure vessel safety evaluation and risk warning based on determined damage mode.

The overall plan may be designed by using safety evaluation method in American Society of Mechanical Engineers (ASME) Specifications, or non-elastic finite element analysis method, which is not limited by the present application.

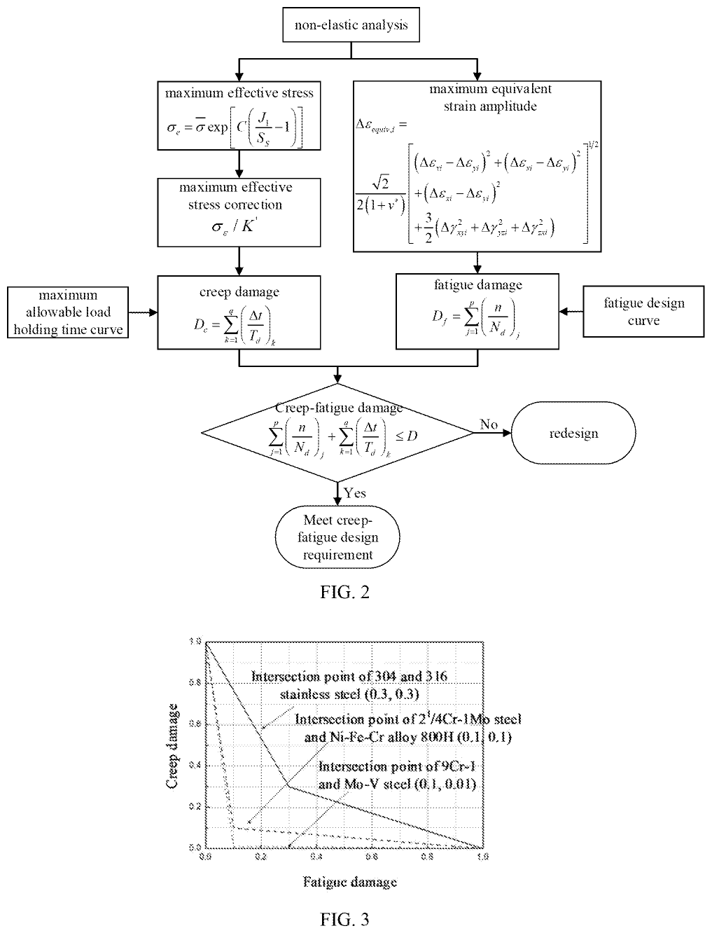

FIG. 2 is a flowchart of pressure vessel creep fatigue damage evaluation in ASME Specifications, the analysis method used here is non-elastic analysis, and for the damage mode of creep fatigue, it mainly includes three parts: first is creep damage calculation; the second is fatigue damage calculation; and the third is creep-fatigue damage evaluation.

When calculating the creep damage, the maximum effective stress σₑ is first calculated, wherein,

$${σ}_{e} = \overline{σ} exp [ C ( \frac{{J}_{1}}{{S}_{s}} - 1 ) ] , {J}_{1} = {σ}_{1} + {σ}_{2} + {σ}_{3} , {S}_{s} = {( {σ}_{1}^{2} + {σ}_{2}^{2} + {σ}_{3}^{2} )}^{1 / 2} ,$$

$$\overline{σ} = 1 / {\sqrt{2} [ {( {σ}_{1} - {σ}_{2} )}^{2} + {( {σ}_{1} - {σ}_{3} )}^{2} + {( {σ}_{2} - {σ}_{3} )}^{2} ]}^{1 / 2} , {σ}_{i} ( i = 1 , 2 , 3 )$$

represents primary stress, C is a constant, and for austenitic steel, C is 0.24. Then, the maximum effective stress is corrected to obtain a corrected value σₑ/K′, in the non-elastic analysis, K′=0.67; then the creep damage D_{c} is calculated according to equation

$${D}_{c} = {\sum }_{k = 1}^{q} {( \frac{Δ t}{{T}_{d}} )}_{k} ,$$

wherein q represents the number of time intervals, T_{d} represents allowable holding time, Δt represents time interval.

When calculating the fatigue damage, the maximum equivalent strain amplitude Δε_{equiv,i} is first calculated, and then the fatigue damage Ds is calculated. Δε_{equiv,i} and D_{f} satisfy the following relationship:

$${Δε}_{equiv , i} = \frac{\sqrt{2}}{2 ( 1 + {v}^{*} )} + {[ \begin{matrix}{( {Δε}_{xi} - {Δε}_{yi} )}^{2} + {( {Δε}_{xi} - {Δε}_{yi} )}^{2} + \\ {( {Δε}_{xi} - {Δε}_{yi} )}^{2} + \\ \frac{3}{2} ( {Δγ}_{xyi}^{2} - {Δγ}_{yzi}^{2} + {Δγ}_{zxi}^{2} )\end{matrix} ]}^{1 / 2} ,$$

wherein, Δεₓᵢ, Δε_{yi}, Δε_{zi} respectively represent differences between normal strains in x, y and z directions and extreme strain at time i.

$${D}_{f} = {\sum }_{j = 1}^{p} {( \frac{n}{{N}_{d}} )}_{j} ,$$

wherein, P is historical number of strain times, N_{d} is number of allowable cycles, and n is number of cycles.

Finally, the creep-fatigue damage is evaluated, when evaluating, it is necessary to rely on the creep-fatigue envelope curve in FIG. 3. If the creep-fatigue damage result is within the envelope curve, the creep-fatigue damage assessment is passed (i.e., D_{c}+D_{f}≤D); if the creep-fatigue damage result is outside the envelope curve, the creep-fatigue damage assessment cannot be passed (D_{c}+D_{f}>D).

The non-elastic finite element analysis method is well-known in the field, the specific steps of which will not be repeated here.

S3: simplify a physical model of the pressure vessel and build a simplified physical model based on designed overall plan.

The simplification of physical model mainly considers the simplification of structural geometric model, including ignoring the influence of structural details such as non-pressure-bearing components (for example flange handles), flange bolts/gaskets, and weld fillet structures of non-load-bearing components. The simplified physical model may be built in Solidworks software and subsequently imported into ABAQUS. A simple model may be built directly by using ABAQUS. If a model is complex, using Solidworks is more convenient and efficient. The simplification of the physical model can ignore some overly complex local structures which have no impact on the safety evaluation result, so that the calculation is simplified.

S4: obtain load condition parameters during actual service of the pressure vessel, including temperature, pressure and so on.

Specifically, signal collectors such as temperature sensors and pressure sensors may be used to obtain simulated signals of temperature and pressure during service.

S5: determine material performance parameters of the pressure vessel according to the designed overall plan.

When the overall plan is designed, the required material performance parameters may be viewed from it, according to the material category of pressure vessel, commonly used material performance parameters can be obtained from specifications or design manuals; the material performance parameters not available in specifications or design manuals can be obtained through material mechanical property test, which are well-known in the field and not be further described here.

S6: build a digital twin model of pressure vessel safety evaluation and risk warning according to the simplified physical model in step S3, the load condition parameters in step S4 and material performance parameters in step S5.

Firstly, the simplified physical model in step S3 is imported into ABAOUS directly, then the simulated signals of temperature and pressure in step S4 are converted into digital signals through an A/D converter, and based on Python language in combination with the load data input format in ABAQUS software, the temperature and pressure loads are read in using an AFTABLE command. The material performance parameters in step S5 are also directly written into a material module of ABAQUS software using Python language, thereby establishing a digital twin model of pressure vessel safety evaluation and risk warning.

S7: conduct a safety evaluation on the digital twin model of pressure vessel safety evaluation and risk warning, and obtain a full-field damage distribution cloud map of the pressure vessel.

A finite element analysis of the digital twin model of pressure vessel safety evaluation and risk warning may be conducted in ABAQUS, and the overall plan of pressure vessel safety evaluation and risk warning in step S2 is embedded (which can be achieved by calling a user subroutine USDFLD, which can integrate the overall plan of pressure vessel safety evaluation and risk warning), thus the full-field damage distribution cloud map of the pressure vessel can be obtained.

S8: compare the full-field damage distribution cloud map and strength requirement of material of pressure vessel, if the strength requirement is met, conduct a safety evaluation at next time node according to subsequent needs of user, and if the strength requirement is not met, output a pressure vessel risk warning.

After the full-field damage distribution cloud map is obtained, the damage is compared to a creep-fatigue interaction diagram of the material to determine whether it meets the creep-fatigue strength requirement. If it meets the strength requirement, a safety evaluation will be conducted at next time node according to subsequent needs of user; and if it does not meet the strength requirement, the pressure vessel risk warning will be output. Specifically, the creep and fatigue damage values of each node in the cloud map are compared to the creep-fatigue damage envelop curve in FIG. 3, if it is inside of the envelope curve, it meets the creep-fatigue strength requirement; and if it is outside of the envelope curve, it does not meet the creep-fatigue strength requirement.

The digital twin-based pressure vessel safety evaluation and risk warning method of the present application can realize the connection of real-time acquisition of pressure vessel service parameters and subsequent life evaluation method, and can overcome the problem that the existing safety evaluation and risk warning technologies for pressure vessel are mostly based on offline data or design data. At the same time, it can also realize the real-time output of pressure vessel risk warning signals based on the evolution of pressure vessel damage. Specifically, the sensors are used to monitor the operating condition information of pressure vessel in real time, providing data support for subsequent safety evaluation of pressure vessel. On this basis, automatic and real-time calculation of pressure vessel damage parameters is realized in finite element software by using user subroutines, and online life evaluation of related components can be achieved. At the same time, related calculation results and local dangerous areas can be displayed in real time, and pressure vessel service risk warning can be realized.

The foregoing description refers to preferred embodiments of the present invention and is not intended to limit the scope of the present invention. Various changes can be made to the foregoing embodiments of the present invention. All simple and equivalent changes and modifications in accordance with the claims of the present invention and the content of the description fall into the protection scope of the patent of the present invention. What is not described in detail in the present invention is conventional technical content.

What is claimed is:

1. A digital twin-based pressure vessel safety evaluation and risk warning method, including following steps:
S1: determining a damage mode of pressure vessel based on design parameters of the pressure vessel and material category of the pressure vessel;
S2: designing an overall plan of pressure vessel safety evaluation and risk warning based on determined damage mode;
S3: simplifying a physical model of the pressure vessel and building a simplified physical model based on designed overall plan;
S4: obtaining load condition parameters during actual service of the pressure vessel;
S5: determining material performance parameters of the pressure vessel according to the designed overall plan;
S6: building a digital twin model of pressure vessel safety evaluation and risk warning according to the simplified physical model in step S3, the load condition parameters in step S4 and the material performance parameters in step S5;
S7: conducting a safety evaluation on the digital twin model of pressure vessel safety evaluation and risk warning, and obtaining a full-field damage distribution cloud map of the pressure vessel;
S8: comparing the full-field damage distribution cloud map and strength requirement of material of pressure vessel, if the strength requirement is met, conducting a safety evaluation at next time node according to subsequent needs of user, and if the strength requirement is not met, outputting a pressure vessel risk warning.

2. The digital twin-based pressure vessel safety evaluation and risk warning method according to claim 1, wherein the design parameters include design temperature and whether there is a cyclic load.

3. The digital twin-based pressure vessel safety evaluation and risk warning method according to claim 1, wherein the material category of pressure vessel is Cr—Mo steel or austenitic steel.

4. The digital twin-based pressure vessel safety evaluation and risk warning method according to claim 1, wherein the damage mode of pressure vessel includes creep damage, creep-fatigue damage and fatigue damage.

5. The digital twin-based pressure vessel safety evaluation and risk warning method according to claim 1, wherein in step S3, the physical model of the pressure vessel is simplified by ignoring non-pressure-bearing components, flange bolts and gaskets, and weld fillet structures of non-load-bearing components.

6. The digital twin-based pressure vessel safety evaluation and risk warning method according to claim 1, wherein the overall plan in step S2 is designed by using American Society of Mechanical Engineers Specifications or non-elastic finite element analysis method.

7. The digital twin-based pressure vessel safety evaluation and risk warning method according to claim 1, wherein the load condition parameters include temperature and pressure.

8. The digital twin-based pressure vessel safety evaluation and risk warning method according to claim 7, wherein in step S4, a temperature sensor and a pressure sensor are used to collect the temperature and pressure of the pressure vessel respectively.

9. The digital twin-based pressure vessel safety evaluation and risk warning method according to claim 1, wherein the material performance parameters of the pressure vessel are obtained by querying in specifications or design manuals or by performing material mechanical property test.

10. The digital twin-based pressure vessel safety evaluation and risk warning method according to claim 1, wherein step S6 further including: importing the simplified physical model in step S3 into ABAQUS software directly, then converting simulated signals of temperature and pressure in step S4 into digital signals through an A/D converter, and inputting the digital signals and material property parameters in step S5 into ABAQUS software by using Python language.
